(19) United States
(12) Patent Application Publication
(10) Pub. No.: US 2006/0082025 A1
(43) Pub. Date: Apr. 20, 2006

(54) Methods for manufacturing fiber molded articles

(76) Inventors: Masanori Hashiba, Kariya-shi (JP); Hideki Kawajiri, Kariya-shi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/243,475

(22) Filed: Oct. 4, 2005

(30) Foreign Application Priority Data
Oct. 12, 2004 (JP) 2004-297649
Mar. 16, 2005 (JP) 2005-75259

(51) Int. Cl. B29C 43/02

(52) U.S. Cl. 264/319

(57) ABSTRACT

A method is taught for manufacturing a fiber molded article that comprises a fibrous material and a binder material. The method includes the steps of molding a base product under heat and pressure, the base product including the fibrous material and a binder material liquid that comprises the binder material fluidized by a fluidizer, and drying the base product under heat and pressure in order to evaporate the fluidizer contained in the base product before the base product is molded. The drying step is performed at a temperature between the boiling point of the fluidizer minus 20° C. and the boiling point of the fluidizer plus 20° C. and below the melting point of the binder material.

This application claims priority to Japanese Patent Application Serial Numbers 2004-297649 and 2005-75259, the contents of which are incorporated herein by reference.

### BACKGROUND OF THE INVENTION

1. Field of the Invention

The present invention relates to methods for manufacturing fiber molded articles. More particularly, the present invention relates to methods for manufacturing fiber molded articles, e.g., fiber molded board, which comprise fibrous materials and binder materials.

2. Description of the Related Art

Methods for manufacturing a fiber molded article such as a fiber molded board are known. In the known methods, fibrous materials such as resin-based fibrous materials or wood-based fibrous materials are bound via binder materials, i.e., thermoplastic resins or thermosetting resins. In the known art, the formed fiber molded article may have varying or uneven physical properties (e.g., unit strength, bending strength and resistance to debonding) that are caused by a nonhomogeneous distribution of the binder materials in the fibrous materials. Therefore, many approaches have been proposed for evenly feeding the binder materials into the fibrous materials.

One approach is taught, for example, by Japanese Patent Number 2718167. In this approach, the fibrous materials are impregnated with an aqueous suspension (dispersion liquid) of binder materials by spraying, thereby producing binder material-impregnated fibrous materials. After drying, the produced binder material-impregnated fibrous materials are assembled and heat treated so as to form a mat-shaped fiber product. Thereafter, the formed fiber product is molded by molding under heat and pressure, thereby manufacturing a fiber molded article. Another approach is taught, for example, by Japanese Laid-Open Patent Publication Number 2002-192507. In this approach, the fibrous materials (kenaf fibers) are previously assembled or pre-shaped so as to form a mat-shaped fiber product. The formed mat-shaped fiber product is dipped in liquefied phenol resins, thereby producing a phenol resin-impregnated mat-shaped fiber product. After drying, the produced phenol resin-impregnated fiber product is molded by molding under pressure, thereby manufacturing a fiber molded article. In addition, a different approach is taught, for example, by Japanese Laid-Open Patent Publication Number 2002-192507. In this approach, the fibrous materials are assembled and pre-shaped while blending with powder binder materials. The pre-shaped fibrous materials are then heat treated, thereby producing a resin-adhered fiber product. The resin-adhered fiber product thus produced is shaped by molding under heat and pressure, thereby manufacturing a fiber molded article.

However, in the first to third approaches, two heat treating steps are required for manufacturing the fiber molded article. As a result, the process for manufacturing the fiber molded article is complicated and time consuming. Also, in the second approach it is difficult to control the amount of the impregnating resins because the fiber product is impregnated with the resins by dipping. Further, in the third approach the binder materials cannot be sufficiently or homogeneously combined with the fibrous materials because the binder materials are used in powdery form. In addition, the powdery binder materials may be easily removed from the fibrous materials (or localized within the fibrous materials), for example, when the pre-shaped fibrous materials are heat treated in order to adhere the binder materials to the fibrous materials.

Further, a fiber product that is impregnated with liquefied phenol resins or an aqueous binder material dispersion liquid can be directly molded without drying, by molding under heat and pressure. However, when such a fiber product is heated during molding, the fiber product may be locally heated so that a suspension medium or a solvent of the resins is locally evaporated within the fibrous materials. As a result, the suspension medium or the solvent may flow toward the locally heated portion of the fiber product so as to move the impregnated resins within the fibrous materials. Thus, the resins may be unevenly dispersed in the fibrous materials.

### SUMMARY OF THE INVENTION

It is, accordingly, one object of the present teachings to provide improved methods for manufacturing a fiber molded article.

For example, in one aspect of the present teachings, a method is taught for manufacturing a fiber molded article that comprises a fibrous material and a binder material. The method includes the steps of molding a base product under heat and pressure, the base product including the fibrous material and a binder material liquid that comprises the binder material fluidized by a fluidizer, and drying the base product under heat and pressure in order to evaporate the fluidizer contained in the base product before the base product is molded. The drying step is performed at a temperature between the boiling point of the fluidizer minus 20° C. and the boiling point of the fluidizer plus 20° C. and below the melting point of the binder material.

According to the present method, in the drying step, the fluidizer of the binder material liquid can be gently or slowly evaporated. Therefore, the fluidizer may effectively be prevented from flowing within the fibrous material of the base product. As a result, the binder material can be effectively prevented from migrating within the fibrous material of the base product.

Further, the binder material liquid can be smoothly penetrated into the fibrous material of the base product because the base product is effectively compressed. Therefore, the binder material can be evenly dispersed within the fibrous material.

Also, the fluidizer of the binder material liquid can be prevented from unevenly evaporating because the base product can be rapidly heated due to the applied pressure. Therefore, the fluidizer may effectively be prevented from flowing within the fibrous material of the base product. As a result, the binder material can be effectively stabilized within the fibrous material without being localized. Thus, according to the present method, it is possible to produce a fiber molded article in which the binder material is homogeneously dispersed within the fibrous material. The fiber molded article thus produced may have an excellent bending strength and a relatively good appearance.

Other objects, features and advantages of the present invention will be readily understood after reading the following detailed description together with the claims.

### DETAILED DESCRIPTION OF THE INVENTION

A representative embodiment of the present teachings will now be described in detail. According to the present teachings, a method will be provided for manufacturing a fiber molded article. Further, the fiber molded article that is manufactured utilizing the present method includes various types of interior finishing members of vehicles and buildings, i.e., board-shaped members that can be molded by various types of press forming including three-dimensional forming. More particularly, such a fiber molded article includes, for example, but is not limited to, a door trim board, an instrument panel, and covering members for doors or furnishings.

In the present method, a fibrous material is previously assembled and shaped so as to make a mat-shaped fiber product. Conversely, a binder material that can bond or combine the fibrous material is mixed with a fluidizing medium or fluidizer that can dissolve or suspend the binder material, thereby formulating a binder material liquid. Consequently, the mat-shaped fiber product is then impregnated with the binder material liquid, thereby producing a binder material-impregnated mat-shaped base product (which will be simply referred to as a “base product”) for manufacturing the fiber molded article. Further, an insert (e.g., a reinforcement member) can be embedded within the mat-shaped fiber product before it is impregnated with the binder material liquid so that the produced base product may contain such an insert therein, if necessary.

The base product thus produced is transferred to a drying step so as to be dried (i.e., so as to evaporate the fluidizer) by heating under pressure. Preferably, the base product is heated to a temperature between the boiling point (B) of the fluidizer minus 20° C. and the boiling point (B) of the fluidizer plus 20° C. (i.e., between B−20° C. and B+20° C.) and below the melting point (M) of the binder material (i.e., <M). In this drying step, the binder material liquid is penetrated into the fibrous material so that the binder material can be evenly dispersed into the fibrous material because the fibrous material of the base product is compressed due to the applied pressure. Therefore, when the base product is dried the binder material can be immobilized within the fibrous material in a condition such that the binder material is homogeneously dispersed therewithin. As a result, upon completion of the drying step the binder material can be stabilized or retained within the fibrous material without being localized.

The base product can be dried by means of various types of heating and pressing methods. For example, the base product can be dried by utilizing a pressing machine disposed within a heating furnace that can be heated to a desired temperature. Also, the base product can be dried by utilizing a pressing machine of which the pressing surfaces or die surfaces can be heated to a desired temperature. Further, the base product can be dried by pressing the base product to a desired thickness utilizing a pressing machine and by heating the pressed base product in a heating furnace.

As described above, the base product may preferably be heated to a temperature between the boiling point (B) of the fluidizer minus 20° C. and the boiling point (B) of the fluidizer plus 20°. If the base product is heated to a temperature below the boiling point of the fluidizer minus 20° C., the evaporation speed of the fluidizer may be extremely delayed. This may lead to prolongation of the drying time of the base product. To the contrary, if the base product is heated to a temperature above the boiling point of the fluidizer plus 20° C., the evaporation speed of the fluidizer may be extremely accelerated. As a result, the binder material can migrate along with the evaporating fluidizer. This may lead to an undesirable localization of the binder material within the fibrous material. Preferably, the base product is heated to a temperature between the boiling point (B) of the fluidizer and the boiling point (B) of the fluidizer plus 10° C. (i.e., between B and B+10° C.) in order to avoid the migration of the binder material caused by the rapid evaporation of the fluidizer. Typically, the base product is heated to a temperature of the boiling point of the fluidizer plus 10° C. (i.e., B+10° C.).

As will be easily understood, the base product is dried by appropriately controlling the pressure applied thereto. That is, the applying pressure is controlled such that the binder material liquid can sufficiently penetrate into the fibrous material without being squeezed out therefrom. Therefore, the amounts and strength of the pressure may preferably be controlled depending upon the types and conditions of the fibrous material and the amounts and flow properties of the fluidizer.

Generally, the base product is sufficiently dried until the fluidizer of the binder material liquid substantially evaporates so that flowability of the binder material liquid is substantially or completely faded away. Preferably, the base product is dried until the binder material liquid is substantially cured so as to not adhere to a carrier or other such members. Further, in a case that the fibrous material is natural fibers such as kenaf fibers that inherently contain water (i.e., water containing fibers), the base product is dried in consideration of such water if water or water compatible liquid is used as the fluidizer. For example, when the base product is composed of kenaf fibers and an aqueous binder material liquid, the base product is dried until the moisture content thereof is reduced to 10% by weight.

In the dried base product, the fibrous material is preferably densified so that the binder material is relatively evenly dispersed within the fibrous material and is reliably retained therewithin. Further, in this drying step the fluidizer is evaporated relatively slowly. Therefore, the binder material can be relatively evenly dispersed throughout the base product, in particular, in the direction of thickness.

The base product thus dried is then transferred to a forming step so as to be shaped or molded, thereby producing the fiber molded article. Typically, the dried base product is transferred to the forming step immediately after the drying step, i.e., before the heat applied to the base product during the drying step is removed therefrom. The reason is that if the dried base product is molded shortly after the drying step, it is possible to reduce the thermal energy and time required to mold the dried base product. Naturally, the dried base product can be tentatively stored before it is transferred to the forming step. Further, in the forming step, the base product can be molded with a covering member, thereby producing the fiber molded article covered with the covering member, if necessary. As will be appreciated, the produced fiber molded article may preferably be provided with attachment members (e.g., a retainer bracket) by fusion welding or adhering, if necessary.

In the forming step, the dried base product is molded by molding under heat and pressure. Typically, the base product is heated to a temperature (a fiber bonding temperature) that permit the binder material to bond or combine the fibrous material. When thermoplastic resins are used as the binder material, the fiber bonding temperature substantially corresponds to the melting point of the thermoplastic resins. Conversely, when thermosetting resins are used as the binder material, the fiber bonding temperature substantially corresponds to the setting temperature of the thermosetting resins.

The dried base product can be molded by means of various types of known molding methods. For example, when a thermoplastic resin is used as the binder material the dried base product is preheated within a heating furnace to a temperature above the melting point of the thermoplastic resin. Further, the heating furnace may preferably be controlled such that the base product is uniformly heated. Thereafter, the heated base product is molded by cold molding so as to produce the fiber molded article. Conversely, when a thermosetting resin is used as the binder material, the dried base product is molded by utilizing a molding machine of which the molding surfaces are heated to the a temperature above the setting temperature of the thermosetting resin. Further, the molding machine may preferably be controlled such that the base product is uniformly heated when molded. For example, both of the molding surfaces are heated such that the base product can be symmetrically heated along the direction of thickness.

As previously described, the binder material in the dried base product is relatively evenly dispersed within the fibrous material and is reliably retained therewithin. Therefore, even if the base product is compressed in the forming step the binder material can be prevented from migrating or localizing within the fibrous material. Consequently, the fibrous material can be relatively evenly bonded or combined by the binder material throughout the base product. Therefore, the fiber molded article produced from such a base product may have less “transparency (lack of hiding)” and “shrinkage.” Further, as described above, the binder material in the base product is more evenly dispersed in the direction of thickness of the base product. Therefore, in a fiber molded article produced from such a base product the binder material is evenly dispersed throughout the article, in particular, in the direction of thickness of the article. In other words, the binder material is evenly present even in the core portion of the fiber molded article. Therefore, the fiber molded article may have an excellent resistance to debonding. In particular, when a combination of natural fibers and a biodegradable binder material is used in order to produce the base product, the fiber molded article may have an increased resistance to moisture and a good resistance to degradation due to humidity and heat. As a result, the fiber molded article may continuously keep a predetermined thickness and a desired strength for a long time.

Further details concerning the fibrous material, the binder material liquid (the binder material and the fluidizer) and the base product will now be described. The fibrous material used in the present embodiment may be various types of known fibers having a relatively long length as compared with the cross-sectional area thereof, e.g., plant-derived fibers, animal-derived fibers, chemical fibers (synthetic fibers), or other such fibers. Representative examples of the fibrous material may include bast fibers of bast plants (e.g., sisal and kenaf); fibers that are obtained by defibrating sugarcane bagasses or woods; cotton fibers; animal hairs; fibers of polyamide resins (nylon), acrylic resins, polyurethane resins and cellulosic resins (rayon). However, non-petrochemical fibers are appropriate for the fibrous material. Kenaf fibers (in particular, kenaf bast fibers) are suitable because they have a long fiber length. Also, kenaf fibers can be effectively and economically available because kenaf is an easily cultivable annual herb.

Further, the fibrous material may be a fiber blend of natural fibers (e.g., the plant-derived fibers and the animal-derived fibers described above) and synthetic fibers, which can melt and bond the natural fibers when heated in the forming step. The synthetic fibers that can be used in order to prepare such a fiber blend may preferably be thermoplastic resin fibers that are formed from thermoplastic resins. It is preferred that the thermoplastic resin fibers can be melted without damaging the natural fibers when they are heated to the fiber bonding temperature in the forming step described above. It is further preferred that the thermoplastic resin fibers not be melted when the fiber blend is heated in the drying step. If the thermoplastic resin fibers are melted or softened in the drying step, the dried base product may become sticky. Such a sticky base product may reduce workability.

Typically, the thermoplastic resin fibers of the fibrous material (the fiber blend) may preferably be formed from the same thermoplastic resins as the thermoplastic resins that can be used as a binder material. Examples of such thermoplastic resins may include polyolefins such as polyethylene and polypropylene; aliphatic polyester resins such as polylactic acid, polycaprolactone, and copolymers of hydroxycarboxylic acid with polylactic acid or polycaprolactone, in particular, hydroxy acid aliphatic polyester resins; polyesters such a PET (polyethylene terephthalate); acetyl cellulose (cellulose acetate) resins; and chemically modified starch resins. Preferably, the thermoplastic resins may be biosynthetically producible compounds such as polylactic acid and polycaprolactam; and plant-based compounds such as acetyl cellulose resins and chemically modified starch resins because these resins may have a reduced environmental load and save oil resources. More preferably, the thermoplastic resins may be polylactic acid because polylactic acid has excellent heat resistance and hardness and can reliably bond the natural fibers (the plant-derived fibers). Further, polyolefins, in particular, polypropylene may be useful in order to form the thermoplastic resin fibers because of their high bonding performance.

The thermoplastic resin fibers of the fiber blend may preferably be formed from thermoplastic resins similar to the thermoplastic resins of the binder material. Such thermoplastic resin fibers may cooperate with the binder material so as to reliably combine or bond the natural fibers. For example, when the binder material liquid is an aqueous suspension or an aqueous dispersion liquid that is formulated by mixing polylactic acid with water, the thermoplastic resin fibers may preferably be formed from polylactic acid.

The amount of the thermoplastic resin fibers may preferably be, but is not limited to, twenty (20) percent or less by weight of the total weight of the fibrous material (the natural fibers and the thermoplastic resin fibers) and the binder material. That is, the weight ratio of the natural fibers to the thermoplastic resin fibers to the binder material may preferably be 6-7:1-2:1-2, e.g., 7:1:2, 7:2:1 and 6:2:2. If the amount of the thermoplastic resin fibers is greater than 20 percent by weight of the total weight of the fibrous material and the binder material, the produced fiber molded article may have a reduced flexural strength. Also, if the amount of the thermoplastic resin fibers is greater than 20 percent by weight of the total weight of the fibrous material and the binder material, the weight of the produced fiber molded article may be increased.

The binder material of the binder material liquid may preferably be made from thermoplastic resins or thermosetting resins that can bond or combine the fibrous material. Examples of the thermoplastic resins may include polyolefins such as polyethylene and polypropylene; aliphatic polyester resins such as polylactic acid, polycaprolactone, and copolymers of hydroxycarboxylic acid with polylactic acid or polycaprolactone, in particular, hydroxy acid aliphatic polyester resins; polyesters such a PET; acetyl cellulose (cellulose acetate) resins; and chemically modified starch resins. Conversely, examples of the thermosetting resins may include polyurethane resins (resins formed from polyisocyanate and polyol), epoxy resins, phenolic resins and urea resins. Preferably, the thermoplastic resins may be biosynthetically producible compounds such as polylactic acid and polycaprolactam; and plant-based compounds such as acetyl cellulose resins and chemically modified starch resins, i.e., resins that are not derived from oil resources. More preferably, the thermoplastic resins may be polylactic acid because polylactic acid has excellent heat resistance and hardness and can reliably bond the natural fibers (the plant-derived fibers). For example, the base product that is produced from kenaf fibers and polylactic acid may not only save oil resources but also may be disposed without producing toxic substances that can deteriorate a working environment and consequently a natural environment.

The fluidizer of the binder material liquid may preferably be solvents that can liquefy the binder material (e.g., various types of organic solvents) or suspension media that can suspend the binder material (e.g., water). Examples of the fluidizer may include ethanol, acetone, water, and mixtures of water and ethanol. Water and water-based aqueous solutions are very suitable because they do not substantially produce toxic substances when evaporated in the drying step and the forming step. Also, the water-based solutions (e.g., a water-based ethanol solution) may effectively reduce the drying time in the drying step because such solutions can more easily evaporate than pure water.

Therefore, in view of the working environment and the natural environment, the suitable binder material liquid may be an aqueous thermoplastic resin dispersion liquid, e.g., an aqueous polylactic acid dispersion liquid (i.e., a suspension in which polylactic acid is dispersed in water or a water-based ethanol solution). Further, the binder material liquid (in particular, the binder material dispersion liquid or suspension) may contain surfactants, emulsifiers or other such additives, if necessary.

As described above, the fibrous material is previously assembled and shaped so as to make a mat-shaped fiber product. Typically, the mat-shaped fiber product may be a mat-shaped fiber assembly or a fortified mat-shaped fiber assembly. The mat-shaped fiber assembly is formed by simply assembling a desired amount (i.e., a desired weight per unit area) of the fibers or the fiber blend. Conversely, the fortified mat-shaped fiber assembly is formed by further treating the mat-shaped fiber assembly, e.g., by needle punching or thermo-compressing the same. The fortified mat-shaped fiber assembly may have excellent workability because of its ease of handling. In particular, when the fortified mat-shaped fiber assembly is formed by needle punching the mat-shaped fiber assembly that is made of a fiber blend of natural fibers (kenaf fibers) and thermoplastic resin fibers, the thermoplastic resin fibers can be reliably entangled with each other by needle punching because the thermoplastic resin fibers are more flexible than the natural fibers. Therefore, the fortified mat-shaped fiber assembly thus formed may have increased cutting characteristics and ease of handling characteristics. Also, because such a fortified mat-shaped fiber assembly can be obtained via a minimal needle punching operation, the natural fibers contained therein may not be damaged.

The mat-shaped fiber product (i.e., the mat-shaped fiber assembly or the fortified mat-shaped fiber assembly) may preferably be impregnated with the binder material liquid by means of various types of known methods, e.g., a spray application method, a roller application method and a dipping method. The spray application method and the roller application method are suitable because such methods can apply the binder material liquid to the mat-shaped fiber product such that the binder material liquid can be evenly dispersed in the fibrous material. Further, the binder material liquid can be applied to the mat-shaped fiber product in various directions. In addition, the binder material liquid can be pre-applied to the fibrous material before the fibrous material is assembled, if necessary.

The following examples show that the fiber molded article that is manufactured utilizing the present method has more excellent properties than the properties of the prior art fiber molded articles. Further, the following examples are illustrative and should not be construed as limitations of the invention.

### EXAMPLE 1

In order to evaluate dispersion uniformity of the binder material liquid (the binder material) within the fibrous material of the fiber molded article, a plurality of samples of the fiber molded article (Samples A and B) were prepared utilizing the present method. Also, a control sample (Control A) was prepared utilizing a known method.

Sample A:

Kenaf fibers (kenaf bast fibers) were assembled in an amount of 0.84 kg/m², thereby forming a mat-shaped fiber product. Polylactic acid (95 weight % or more L-form) was mixed with water, thereby formulating an aqueous dispersion liquid of polylactic acid, i.e., an aqueous polylactic acid dispersion liquid (30 weight % polylactic acid content). A desired amount of the aqueous dispersion liquid thus formulated was applied to the mat-shaped fiber product by spraying such that the amount of applied polylactic acid was about 30 weight % of the total weight of kenaf fibers and polylactic acid (i.e., such that the weight ratio of kenaf fibers to polylactic acid was 7:3), thereby producing a polylactic acid-impregnated mat-shaped base product. Thereafter, the base product was dried in a pressing machine of which the pressing dies were heated to 110° C., under a pressure of 15 kgf/cm² for three minutes. Subsequently, the dried base product was molded in a molding machine of which the molding dies were heated to 230° C., under a pressure of 24 kgf/cm² for 100 seconds, thereby producing a plate-shaped fiber molded article. At this time, the base product was heated to about 210° C. The produced fiber molded article had a weight per unit area of 1.2 kg/m².

Sample B:

Similar to Sample A, kenaf fibers were assembled in an amount of 0.84 kg/m², thereby forming a mat-shaped fiber product. The formed mat-shaped fiber product was sliced or divided equally into two thinned parts having the same thickness. Thereafter, the aqueous polylactic acid dispersion liquid (30 weight % polylactic acid content) formulated as described above was applied to the upper surface of one part of the sliced fiber product. The amount of the aqueous dispersion liquid was substantially identical to the amount used in Sample A. One part thus treated was combined with the other part of the sliced fiber product such that the aqueous dispersion liquid, applied to the one part, was substantially sandwiched between the two parts, thereby producing a polylactic acid-impregnated mat-shaped base product. Thereafter, the base product was dried and molded under the same conditions as for Sample A, thereby producing a plate-shaped fiber molded article having weight per unit area of 1.2 kg/m².

Control A:

Similar to Sample A, a polylactic acid-impregnated mat-shaped base product was produced. The base product thus produced was molded in a molding machine of which the molding dies were heated to 230° C., under a pressure of 24 kgf/cm² for 180 seconds, thereby producing a plate-shaped fiber molded article. At this time, the base product was heated to about 210° C. As will be recognized, the base product was not previously dried before it was molded.

Each of Samples A and B and Control A was sliced or divided equally into three thinned parts having the same thickness, i.e., an upper part, a middle part and a lower part. Thereafter, ten (10) mg specimens were taken from the upper part, the middle part and the lower part and placed into an aluminum cell. Conversely, ten (10) mg of pure (100%) polylactic acid (standard polylactic acid) that was treated by heating to 210° C. was placed into an aluminum cell. Each of the cells that contained the specimens or the cell that contained pure polylactic acid and an additional empty cell were symmetrically disposed into a heating furnace. Thereafter, the heating furnace was heated to 210° C. at a rate of temperature increase of 10° C./min so as to determine heat of fusion (J/g) of polylactic acid of each of the specimens and the standard polylactic acid at a temperature of 175° C. From the determined values of heat of fusion, a rate of resin content (%) in each specimen was calculated by the following equation:

$$Rate of Resin Contnt ( \% ) = \frac{Heat of Fusion of Polylactic Acid of Specimen ( J \text{/} g )}{Heat of Fusion of Standard Polylactic Acid ( J \text{/} g )} \times 100$$

Results are shown in Table 1. Further, the rate of resin content of each part is shown by an index number based on a minimum value (1.0) in these parts for comparison purposes.

TABLE 1

| | Rate of Resin Content (Index Number) | | |
|---|---|---|---|
| | Upper Part | Middle Part | Lower Part |
| Sample A | 1.1 | 1.0 | 1.0 |
| Sample B | 1.0 | 1.1 | 1.0 |
| Control A | 1.5 | 1.0 | 1.5 |

Table 1 demonstrates that each of Samples A and B has excellent dispersion uniformity of the binder material liquid (the binder material) within the fibrous material of the fiber molded article. That is, according to the fiber molded article prepared utilizing the present method, the binder material liquid (the binder material) may be substantially uniformly dispersed within the fibrous material along the thickness direction. On the contrary, in the Control A the binder material liquid (the binder material) is not uniformly dispersed within the fibrous material of the fiber molded article. That is, according to the fiber molded article prepared utilizing the conventional method, the binder material liquid (the binder material) is localized in the upper and lower parts.

### EXAMPLE 2

In order to evaluate the bending strength and appearance of the fiber molded article, a plurality of samples of the fiber molded article (Samples 1-11) were prepared utilizing the present method. Also, a plurality of control samples (Controls 1-3) were prepared utilizing a known method.

Sample 1:

A polylactic acid-impregnated mat-shaped base product was produced via the same process as in Sample A. Thereafter, similar to Sample A, the base product thus produced was dried. Subsequently, the dried base product was molded in the same molding machine and under the same conditions as for Sample A, thereby producing a plate-shaped fiber molded article. A part of the fiber molded article thus produced was then heated for three minutes in an oven at 235° C. so as to be heated to 210° C. The heated fiber molded article thus produced was further molded (three-dimensionally molded) by cold molding, thereby producing a hat-shaped fiber molded article having a drawn portion 7 cm deep.

Sample 2:

A polylactic acid-impregnated mat-shaped base product was produced via the same process as in Sample B. Thereafter, similar to Sample B, the base product was dried and molded, thereby producing a plate-shaped fiber molded article. A part of the fiber molded article thus produced was further molded via the same process as in Sample 1, thereby producing a hat-shaped fiber molded article.

Sample 3:

Kenaf fibers (kenaf bast fibers) having a fiber length of 70 mm and fibers (6.6 dtex×51 mm) made of polylactic acid (i.e., synthetic fibers) were assembled in an amount of 0.96 kg/m², thereby forming a mat-shaped fiber product. The weight ratio of kenaf fibers to the polylactic acid fibers was 7:1. Polylactic acid (95 weight % or more L-form) was mixed with water, thereby formulating an aqueous polylactic acid dispersion liquid (20 weight % polylactic acid content). A desired amount of the aqueous dispersion liquid thus formulated was applied to the mat-shaped fiber product by spraying such that the weight ratio of kenaf fibers to applied polylactic acid (the binder material) was 7:2, thereby producing a polylactic acid-impregnated mat-shaped base product. Thereafter, the base product thus produced was dried in a pressing machine of which the pressing dies were heated to 110° C., under a pressure of 15 kgf/cm² for three minutes. Subsequently, the dried base product was molded in a molding machine of which the molding dies were heated to 230° C., under a pressure of 24 kgf/cm² for 90 seconds, thereby producing a plate-shaped fiber molded article. At this time, the base product was heated to about 210° C. The produced fiber molded article had weight per unit area of 1.2 kg/m². A part of the fiber molded article thus produced was further molded via the same process as in Sample 1, thereby producing a hat-shaped fiber molded article.

Sample 4:

Kenaf fibers (kenaf bast fibers) and fibers made of polylactic acid were assembled at an amount of 1.080 kg/m², thereby forming a mat-shaped fiber product. The weight ratio of kenaf fibers to the polylactic acid fibers was 7:2. Similar to Sample 3, an aqueous polylactic acid dispersion liquid (20 weight % polylactic acid content) was formulated. A desired amount of the aqueous dispersion liquid thus formulated was applied to the mat-shaped fiber product by spraying such that the weight ratio of kenaf fibers to polylactic acid (the binder material) was 7:1, thereby producing a polylactic acid-impregnated mat-shaped base product. Thereafter, the base product thus produced was treated via the same process as in Sample 3, thereby producing a plate-shaped fiber molded article. A part of the fiber molded article thus produced was further molded via the same process as in Sample 1, thereby producing a hat-shaped fiber molded article.

Sample 5:

Kenaf fibers (kenaf bast fibers) and fibers made of polylactic acid were assembled in an amount of 0.84 kg/m², thereby forming a mat-shaped fiber product. The weight ratio of kenaf fibers to the polylactic acid fibers was 6:1. Similar to Sample 3, an aqueous polylactic acid dispersion liquid (20 weight % polylactic acid content) was formulated. A desired amount of the aqueous dispersion liquid thus formulated was applied to the mat-shaped fiber product by spraying such that the weight ratio of kenaf fibers to polylactic acid (the binder material) was 6:3, thereby producing a polylactic acid-impregnated mat-shaped base product. Thereafter, the base product thus produced was treated via the same process as in Sample 3, thereby producing a plate-shaped fiber molded article. A part of the fiber molded article thus produced was further molded via the same process as in Sample 1, thereby producing a hat-shaped fiber molded article.

Sample 6:

Kenaf fibers (kenaf bast fibers) and fibers made of polylactic acid were assembled in an amount of 0.96 kg/m², thereby forming a mat-shaped fiber product. The weight ratio of kenaf fibers to the polylactic acid fibers was 6:2. Similar to Sample 3, an aqueous polylactic acid dispersion liquid (20 weight % polylactic acid content) was formulated. A desired amount of the aqueous dispersion liquid thus formulated was applied to the mat-shaped fiber product by spraying such that the weight ratio of kenaf fibers to polylactic acid (the binder material) was 6:2, thereby producing a polylactic acid-impregnated mat-shaped base product. Thereafter, the base product thus produced was treated via the same process as in Sample 3, thereby producing a plate-shaped fiber molded article. A part of the fiber molded article thus produced was further molded via the same process as in Sample 1, thereby producing a hat-shaped fiber molded article.

Sample 7:

Kenaf fibers (kenaf bast fibers) and fibers made of polylactic acid were assembled at an amount of 1.08 kg/m², thereby forming a mat-shaped fiber product. The weight ratio of kenaf fibers to the polylactic acid fibers was 6:3. Similar to Sample 3, an aqueous polylactic acid dispersion liquid (20 weight % polylactic acid content) was formulated. A desired amount of the aqueous dispersion liquid thus formulated was applied to the mat-shaped fiber product by spraying such that the weight ratio of kenaf fibers to polylactic acid (the binder material) was 6:1, thereby producing a polylactic acid-impregnated mat-shaped base product. Thereafter, the base product thus produced was treated via the same process as in Sample 3, thereby producing a plate-shaped fiber molded article. A part of the fiber molded article thus produced was further molded via the same process as in Sample 1, thereby producing a hat-shaped fiber molded article.

Sample 8:

This sample was produced similar to Sample 3 except that fibers made of polypropylene were used as the synthetic fibers.

Sample 9:

This sample was produced similar to Sample 4 except that fibers made of polypropylene were used as the synthetic fibers.

Sample 10:

This sample was produced similar to Sample 5 except that fibers made of polypropylene were used as the synthetic fibers.

Sample 11:

This sample was produced similar to Sample 6 except that fibers made of polypropylene were used as the synthetic fibers.

Control 1:

A polylactic acid-impregnated mat-shaped base product was produced via the same process as in Control A. Thereafter, the base product was molded in the same molding machine and under the same conditions as for Control A, thereby producing a plate-shaped fiber molded article. A part of the fiber molded article thus produced was further molded via the same process as in Sample 1, thereby producing a hat-shaped fiber molded article.

Control 2:

Kenaf fibers (kenaf bast fibers) and fibers made of polylactic acid were assembled in an amount of 1.25 kg/m², thereby forming a mat-shaped fiber product. The weight ratio of kenaf fibers to the polylactic acid fibers was 7:3. The mat-shaped fiber product thus formed was directly molded in a molding machine of which the molding dies were heated to 230° C., under a pressure of 24 kgf/cm² for 60 seconds, thereby producing a plate-shaped fiber molded article. At this time, the fiber product was heated to about 210° C. The produced fiber molded article had weight per unit area of 1.2 kg/m². A part of the fiber molded article thus produced was further molded via the same process as in Sample 1, thereby producing a hat-shaped fiber molded article. As will be recognized, unlike Control 1, the fiber product was not impregnated with an aqueous dispersion liquid. That is, a dispersion liquid-impregnated mat-shaped base product was not produced before molding.

Control 3:

This control was produced similar to Control 2 except that the weight ratio of kenaf fibers to the polylactic acid fibers was 6:4.

With regard to each of Samples 1-11 and Controls 1-3, the plate-shaped fiber molded article was partly cut away so as to form a 50 mm×150 mm test piece. The test piece thus formed was used in order to determine the bending strength of the fiber molded article. The bending strength was determined by a three point bending method. That is, the bending strength was determined by pressing the central portion of a test piece that was supported at both longitudinal ends. From the determined values, the bending strength of the fiber molded article was evaluated based on the following reference levels:
A (Superior): not less than 30 Mpa
B (Inferior): less than 30 Mpa
   Results are shown in Table 2.

In addition, with regard to each of Samples 1-11 and Controls 1-3, the hat-shaped fiber molded article was visually evaluated for the appearance, i.e., “tearing,” “transparency (lack of hiding)” and “scuffing.” The appearance of the fiber molded article was evaluated based on the following criteria:

Tearing
A (Superior): no tearing
B (Ordinary): tearing without opening
C (Inferior): opening

Transparency
A (Superior): no transparency
B (Ordinary): transparency without opening
C (Inferior): opening

Scuffing
A (Superior): no scuffing
B (Ordinary): slight scuffing
C (Inferior): significant scuffing

Results are shown in Table 2.

TABLE 2

| | | Appearance | | |
|---|---|---|---|---|
| | Bending Strength | Tearing | Transparency | Scuffing |
| Sample 1 | A | A | C | C |
| Sample 2 | A | A | C | C |
| Sample 3 | A | A | A | B |
| Sample 4 | A | A | A | B |
| Sample 5 | A | A | A | A |
| Sample 6 | A | A | A | A |
| Sample 7 | B | A | A | A |
| Sample 8 | A | A | A | B |
| Sample 9 | A | A | A | B |
| Sample 10 | A | A | A | A |
| Sample 11 | A | A | A | A |
| Control 1 | A | C | C | C |
| Control 2 | B | B | C | B |
| Control 3 | B | A | A | A |

Table 2 demonstrates that the fiber molded article may have excellent bending strength when an aqueous dispersion liquid is applied to the kenaf fibers such that the amount of the binder material is not less than 20 weight % of the total weight of kenaf fibers, the synthetic fibers, and the binder material (Samples 1-6, 8-11 and Control 1). Also, Table 2 demonstrates that the fiber molded article may have inferior bending strength when synthetic fibers (the polylactic acid fibers) are added to the kenaf fibers such that the amount of the synthetic fibers is greater than 20 weight % of the total weight of kenaf fibers, the synthetic fibers, and the binder material (Sample 7 and Controls 2 and 3). This result indicates that it is preferable that the amount of the synthetic fibers is not greater than 20 weight % of the total weight of kenaf fibers, the synthetic fibers, and the binder material.

As will be apparent from Table 2, the fiber molded article in which synthetic fibers (the polylactic acid fibers) are not added to the kenaf fibers may generally produce “transparency” and “scuffing” (Samples 1 and 2 and Control 1). Also, the fiber molded article in which the aqueous dispersion liquid is not used may generally produce an inferior appearance (Control 2). Further, the fiber molded article in which the synthetic fibers (the polylactic acid fibers) are added to the kenaf fibers and in which the aqueous dispersion liquid is applied to the fiber blend may generally produce good results (Samples 3-11). In particular, the fiber molded article in which the weight ratio of kenaf fibers to the synthetic fibers plus the binder material is 6:4 may produce good results (Samples 5-7, 10 and 11, and Control 3). This means that such a fiber molded article can be suitably three-dimensionally molded.

As a result, in order to produce a useful fiber molded article having an increased bending strength and good appearance, it is preferable that synthetic fibers (e.g., the polylactic acid fibers) are added to the natural fibers (e.g., the kenaf fibers) so as to form the fiber blend. Further, it is preferable that the aqueous dispersion liquid of the binder material is applied to the fibers such that the weight ratio of the natural fibers to the synthetic fibers plus the binder material is 7:3-6:4.

This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present teachings.

1. A method for manufacturing a fiber molded article that comprises a fibrous material and a binder material, comprising:
molding a base product under heat and pressure, the base product including the fibrous material and a binder material liquid that comprises the binder material fluidized by a fluidizer; and
drying the base product under heat and pressure in order to evaporate the fluidizer contained in the base product before the base product is molded,
wherein the drying step is performed at a temperature between the boiling point of the fluidizer minus 20° C. and the boiling point of the fluidizer plus 20° C. and below the melting point of the binder material.

2. A method as defined in claim 1, wherein the fluidizer comprises water, and wherein the drying step is performed at a temperature not less than 100° C. and not greater than 110° C.

3. A method as defined in claim 1, wherein the molding step is performed at a temperature that permit the binder material to bond the fibrous material of the base product.

4. A method as defined in claim 1, wherein the fibrous material comprises natural fibers, and wherein the binder material liquid comprises an aqueous thermoplastic resin dispersion liquid.

5. A method as defined in claim 1, wherein the fibrous material comprises a fiber blend of natural fibers and thermoplastic resin fibers, and wherein the binder material liquid comprises an aqueous thermoplastic resin dispersion liquid.

6. A method as defined in claim 4, wherein the aqueous thermoplastic resin dispersion liquid comprises an aqueous polylactic acid dispersion liquid.

7. A method as defined in claim 5, wherein the thermoplastic resin fibers comprises polylactic acid fibers, and wherein the aqueous thermoplastic resin dispersion liquid comprises an aqueous polylactic acid dispersion liquid.

8. A method as defined in claim 5, wherein the thermoplastic resin fibers comprises polypropylene fibers, and wherein the aqueous thermoplastic resin dispersion liquid comprises an aqueous polylactic acid dispersion liquid.

9. A method for manufacturing a fiber molded article that comprises natural fibers and polylactic acid as a binder material, comprising:
molding a base product under heat and pressure, the base product including natural fibers and a binder material liquid that comprises polylactic acid fluidized by a fluidizer; and
drying the base product under heat and pressure in order to evaporate the fluidizer contained in the base product before the base product is molded,
wherein the drying step is performed at a temperature between the boiling point of the fluidizer minus 20° C. and the boiling point of the fluidizer plus 20° C. and below the melting point of polylactic acid.

10. A method as defined in claim 9, wherein the natural fibers comprises kenaf fibers.

11. A method for manufacturing a fiber molded article that comprises natural fibers, thermoplastic resin fibers and polylactic acid as a binder material, comprising:
molding a base product under heat and pressure, the base product including a fiber blend of the natural fibers and the thermoplastic resin fibers and a binder material liquid that comprises polylactic acid fluidized by a fluidizer; and
drying the base product under heat and pressure in order to evaporate the fluidizer contained in the base product before the base product is molded,
wherein the drying step is performed at a temperature between the boiling point of the fluidizer minus 20° C. and the boiling point of the fluidizer plus 20° C. and below the melting point of polylactic acid.

12. A method as defined in claim 11, wherein the natural fibers comprises kenaf fibers.

13. A method as defined in claim 11, wherein the thermoplastic resin fibers comprises polylactic acid fibers.

14. A method as defined in claim 11, wherein the thermoplastic resin fibers comprises polypropylene fibers.
